(19) United States
(12) Patent Application Publication
(10) Pub. No.: US 2026/0175926 A1
(43) Pub. Date: Jun. 25, 2026

(54) VEHICLE FRONTAL STRUCTURE

(71) Applicant: TOYOTA JIDOSHA KABUSHIKI KAISHA, Toyota-shi (JP)

(72) Inventors: Hiromu KOTAKI, Sato-shi (JP); Shizuma Uju, Nisshin-shi (JP); Koji Amemiya, Okazaki-shi (JP)

(73) Assignee: TOYOTA JIDOSHA KABUSHIKI KAISHA, Toyota-shi (JP)

(21) Appl. No.: 19/368,427

(22) Filed: Oct. 24, 2025

(30) Foreign Application Priority Data
Dec. 20, 2024 (JP) 2024-225339

(51) Int. Cl. B62D 25/18; B62D 21/03; B62D 25/04; B62D 25/08

(52) U.S. Cl. CPC B62D 25/18; B62D 21/03; B62D 25/04; B62D 25/088

(57) ABSTRACT

A triangular rib that connects the inner surface sides of the pair of left and right front pillars and the crossmember and forms a substantially triangular shape when viewed from the rearward side of the vehicle is provided on the boundary portion of the front pillar with the crossmember. Thus, after the integrally molded member is molded, the deformation of the front pillar toward the inside in the vehicle width direction can be resisted by the compressive force of the triangular rib, it is possible to suppress the deformation of the front pillar.

### CROSS-REFERENCE TO RELATED APPLICATION

This application claims priority to Japanese Patent Application No. 2024-225339 filed on Dec. 20, 2024. The disclosure of the above-identified application, including the specification, drawings, and claims, is incorporated by reference herein in its entirety.

### BACKGROUND

### 1. Technical Field

The present disclosure relates to a vehicle frontal structure.

### 2. Description of Related Art

CN117565978 discloses technology relating to a vehicle frontal structure including a cast body formed by die casting. In this related art, the cast body is integrally formed from a pair of suspension towers supporting upper end portions of suspensions of front wheels, over right and left wheelhouses that are respectively provided on a vehicle rearward side of the front wheels. The right and left wheelhouses are connected by a crossmember extending in a vehicle width direction and making up a framework at a lower front end portion of a cabin.

### SUMMARY

Now, in the above-described related art, a plurality of ribs is formed on an outer side in the vehicle width direction of the cast body. Accordingly, when the cast body is released from a mold for molding the cast body, there is a possibility that the cast body (integrally molded member) will be deformed under release resistance that is caused by the ribs having been formed.

In view of the above circumstances, an object of the present disclosure is to provide a vehicle frontal structure that is capable of suppressing deformation of an integrally molded member when molding the integrally molded member.

A vehicle frontal structure according to a first aspect includes a pair of right and left wheelhouses, each configured including an upright wall portion that extends in a vehicle front-rear direction and also a vehicle up-down direction, with respective right and left front wheels being disposed in each of the wheelhouses, a crossmember that extends in a vehicle width direction to connect the right and left wheelhouses, and that is integrally molded with the right and left wheelhouses, and a pair of right and left pillars that is provided on a rearward side in the vehicle front-rear direction from the right and left wheelhouses, respectively, and extending in the vehicle front-rear direction and also in the vehicle up-down direction, and integrally molded with the right and left wheelhouses, in which first ribs are each fashioned connecting inner face sides of the right and left pillars in the vehicle width direction with the crossmember.

The vehicle frontal structure according to the first aspect includes the right and left wheelhouses, the crossmember, and the right and left pillars. The right and left front wheels can be disposed in the right and left wheelhouses, respectively, and the right and left wheelhouses are each configured including the upright wall portions extending in the vehicle front-rear direction and also the vehicle up-down direction.

Also, the crossmember extends in the vehicle width direction so as to connect the right and left wheelhouses, and is integrally molded with the right and left wheelhouses. Further, the right and left pillars are each provided on the rearward side in the vehicle front-rear direction from the right and left wheelhouses, each extending in the vehicle front-rear direction and also the vehicle up-down direction, and are integrally molded with the right and left wheelhouses. That is to say, in this aspect, the right and left wheelhouses, the crossmember, and the right and left pillars are integrally molded (integrally molded member).

Now, in this aspect, the first ribs are each formed connecting the inner face sides of the right and left pillars in the vehicle width direction and the crossmember. Due to the first ribs being formed in this way, deformation of the right and left pillars, which tend to collapse toward the inward side in the vehicle width direction, can be countered by compressive force of the first ribs after the integrally molded member is molded. Deformation of the pillars can be suppressed.

With the vehicle frontal structure according to a second aspect, in the vehicle frontal structure according to the first aspect, each first rib is provided including a boundary portion of each pillar with respect to the crossmember, and is a triangular rib with a substantially triangular shape as viewed from a vehicle rearward side.

In the vehicle frontal structure according to the second aspect, the first ribs are provided including boundary portions of the pillars as to the crossmember, and are triangular ribs with substantially triangular shapes as viewed from the vehicle rearward side. Thus, according to this aspect, forming the triangular ribs at the boundary portions between the pillars and the crossmember enables deformation of the pillars to be effectively suppressed with a minimal size and also a simple shape.

With the vehicle frontal structure according to a third aspect, in the vehicle frontal structure according to the first aspect or the second aspect, second ribs are erected from outer faces of the pillars in the vehicle width direction along the vehicle up-down direction.

In the vehicle frontal structure according to the third aspect, the second ribs are erected from the outer faces of the pillars in the vehicle width direction, and the second ribs are formed along the vehicle up-down direction. Thus, in this aspect, when the integrally molded member is released from the mold at the time of molding the integrally molded member, release resistance by the second ribs is applied to the pillars. When the integrally molded member is released from the mold, a force toward outer side in the vehicle width direction acts on the right and left pillars. due to this release resistance. As a result, in this aspect, deformation (collapsing) of the right and left pillars inward in the vehicle width direction can be suppressed with a simple configuration.

With the vehicle frontal structure according to a fourth aspect, in the vehicle frontal structure according to any one aspect of the first aspect to the third aspect, a plurality of third ribs is erected from each of the upright wall portions toward an outer side in the vehicle width direction, between a suspension tower that is provided in the wheelhouse, and the pillar.

In the vehicle frontal structure according to the fourth aspect, the third ribs are erected between the suspension tower that is provided in the wheelhouse and the pillar, and the third ribs are each formed from the upright wall portion toward the outer side in the vehicle width direction. The rigidity between the suspension tower and the pillar (so-called upper member) can be improved, and deformation of the upper member can be suppressed.

With the vehicle frontal structure according to a fifth aspect, in the vehicle frontal structure according to the fourth aspect, a draft angle of the third ribs is greater in inclination angle than a draft angle of the ribs at portions other than at the upper member.

In the vehicle frontal structure according to the fifth aspect, the draft angle of the third ribs is greater in the inclination angle than the draft angle of the ribs at portions other than the upper member (e.g., the wheelhouses), and thus releasability of the third ribs can be improved. Thus, in this aspect, when the integrally molded member is released from the mold at the time of molding the integrally molded member, adverse effects (deformation or the like) of releasability can be reduced due to providing the third ribs.

As described above, in the vehicle frontal structure according to the present disclosure, deformation of the integrally molded member can be suppressed when molding the integrally molded member.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a vehicle to which a vehicle frontal structure according to an embodiment of the present disclosure is applied as viewed from a vehicle left oblique publication and an upper side;

FIG. 2A is a schematic cross-sectional view illustrating a draft angle of a third rib formed on an upper member constituting a part of the vehicle frontal structure of the present embodiment; and

FIG. 2B is a schematic cross-sectional view showing a draft angle in a part other than an upper member showing a comparative embodiment of 2A of the present.

### DETAILED DESCRIPTION OF EMBODIMENTS

Hereinafter, a vehicle frontal structure according to an embodiment of the present disclosure will be described with reference to the drawings. Note that an arrow FR appropriately shown in the drawings indicates a front side in the vehicle front-rear direction, and an arrow UP indicates an upper side in the vehicle up-down direction. The arrow RH indicates the right side in the vehicle width direction, and in the present embodiment, indicates the outer side in the vehicle width direction. Hereinafter, in the case of simply describing the front-rear direction, the up-down direction, and the left-right direction, unless otherwise specified, the front-rear direction of the vehicle front-rear direction, the up-down direction of the vehicle up-down direction, and the left-right direction of the vehicle (vehicle width direction) are represented.

### Configuration of Vehicle Frontal Structure

First, the configuration of the vehicle frontal structure according to the present embodiment will be described.

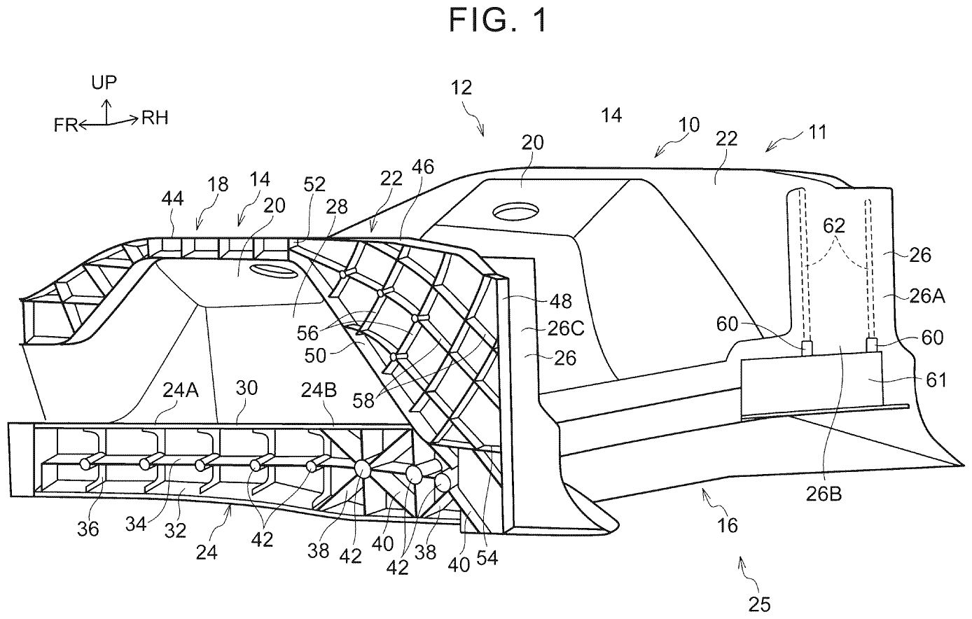

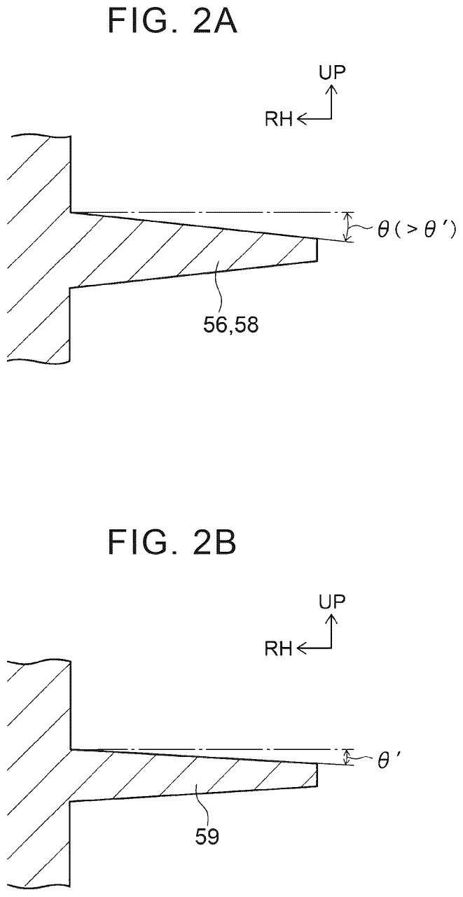

FIG. 1 shows a front portion (vehicle front portion) 11 of a vehicle 12 to which the vehicle frontal structure 10 according to the present embodiment is applied. Although not shown, the vehicles 12 are, for example, a battery electric vehicle and a fuel cell electric vehicle that travel with power generated by a power unit.

The vehicle 12 shown in FIG. 1 is provided with a wheelhouse 14 in which front wheels (not shown) are arranged on the left and right sides of the vehicle front portion 11, and the wheelhouse 14 on the right side and the wheelhouse 14 on the left side are connected by a crossmember 16. An apron upper member 18 extends along the vehicle front-rear direction at an upper end portion of each wheelhouse 14. A suspension tower (hereinafter referred to as a “suspension tower”) 20 is provided inside the apron upper member 18 in the vehicle width direction.

An upper member 22 extending in the vehicle up-down direction and the vehicle front-rear direction is provided on the rear side of the suspension tower 20 and on the outer side in the vehicle width direction than the suspension tower 20. A front side member 24 extending in the vehicle up-down direction and the vehicle front-rear direction is provided on the lower side of the suspension tower 20 and the upper member 22. On the rear side of the upper member 22 and the front side member 24, a front pillar 26 extending in the vehicle up-down direction and the vehicle front-rear direction is provided.

A front end portion of a roof side rail that supports an upper end portion of a front door (not shown) and extends in the vehicle front-rear direction is coupled to an upper end portion of the front pillar 26. Further, a front end portion of a rocker extending in the vehicle front-rear direction and outside in the vehicle width direction of a floor panel (not shown) is connected to a lower side of the front pillar 26.

In the present embodiment, the left and right wheelhouses 14 including the suspension tower 20 and the front side member 24, the left and right upper members 22, the crossmember 16, and the front pillar 26 are integrally molded by casting using, for example, an aluminum alloy, a magnesium alloy, or the like as a material (integrally molded member 25).

In the integrally molded member 25 of the present embodiment, due to the structure of the mold, for example, in the formation of the outer surface in the vehicle width direction in the wheelhouse 14, the upper member 22, and the front pillar 26, the mold is slid outward in the vehicle width direction. Therefore, the wheelhouse 14 and the front pillar 26 in the present embodiment are formed such that the outside in the vehicle width direction is an opening.

### Wheelhouse

First, the wheelhouse 14 according to the present embodiment will be described.

As described above, the pair of left and right wheelhouses 14 includes the suspension tower 20 and the front side member 24, respectively. As shown in FIG. 1, the wheelhouse 14 includes an upright wall portion 28 extending in the vehicle front-rear direction and the vehicle up-down direction inside a fender panel of a vehicle (not shown). The upright wall portion 28 is formed to bulge toward the inside in the vehicle width direction along the shape of the suspension tower 20 on the upper side of the front side member 24, which will be described later.

Further, an apron upper member 18 is provided at an upper end portion of the wheelhouse 14 as described above, and a front side member 24 extends in the vehicle front-rear direction at a lower portion of the wheelhouse 14.

The front side member 24 includes an upper wall portion 30 that constitutes an upper end portion of the front side member 24 extending along the vehicle front-rear direction, and a lower wall portion 32 that constitutes a lower end portion of the front side member 24. Between the upper wall portion 30 and the lower wall portion 32, a plurality of lateral wall portions 34 are extended along the vehicle front-rear direction, and the upper wall portion 30, the lower wall portion 32, and the lateral wall portion 34 are respectively erected from the upright wall portion 28 toward the outside in the vehicle width direction.

Further, on the front portion 24A side of the front side member 24, a plurality of vertical ribs 36 are provided between the upper wall portion 30 and the lower wall portion 32 along the vehicle up-down direction, and these vertical ribs 36 are arranged along the vehicle front-rear direction.

On the other hand, on the rear portion 24B of the front side member 24, a plurality of inclined ribs 38 and inclined ribs 40 are provided between the upper wall portion 30 and the lower wall portion 32. The inclined rib 38 is inclined toward the vehicle upper side toward the vehicle rear side. The inclined rib 40 is inclined toward the vehicle lower side toward the vehicle rear side. The inclined ribs 38 and the inclined ribs 40 are connected to each other between the lateral wall portions 34 and form a truss structure in appearance. As described above, the inclined ribs 38 and the inclined ribs 40 are connected to each other between the lateral wall portions 34, so that a bending moment is hardly generated and deformation is suppressed.

In addition, a boss 42 having a substantially cylindrical shape or a substantially cylindrical shape is provided at an intersection point between the inclined ribs 38 and 40 and the lateral wall portion 34, and at the lateral wall portion 34. These bosses 42, when molding the integrally molded member 25 including the wheelhouse 14, the extrusion pin (not shown) used in releasing the integrally molded member 25 from the mold is a pedestal to abut.

Note that the position, size, and the like of the boss 42 can be appropriately changed by the mass balance of the integrally molded member 25. Further, the boss 42 may be used not only as a pedestal against which the extrusion pin abuts, but also as a pedestal for fastening with other components.

### Upper Member

Next, the upper member 22 in the present embodiment will be described.

In the present embodiment, the pair of left and right upper members 22 are provided between the suspension tower 20 and the front pillar 26 of the wheelhouse 14 along the vehicle front-rear direction, and on the upper side of the front side member 24.

The upper member 22 includes an upright wall portion 28 that is connected to the wheelhouse 14 and extends in the vehicle front-rear direction and the vehicle up-down direction inside the vehicle width direction. Further, the upper member 22 has a substantially triangular shape in a side view viewed from the outside of the vehicle. At the upper end of the upper member 22, an upper wall portion 46 connected to the upper end portion 44 constituting the upper end of the apron upper member 18 is erected from the upper end of the upright wall portion 28 toward the outside in the vehicle width direction. The upper wall portion 46 extends along the vehicle front-rear direction.

Further, the rear end of the upper member 22, the rear wall portion 48 forming a boundary between the rear end of the upper wall portion 46 and the front pillar 26 is erected from the rear end of the upright wall portion 28 toward the outside in the vehicle width direction, is formed along the vehicle up-down direction. Further, the front end of the upper member 22, the inclined rib 50 forming a boundary with the wheelhouse 14 is erected toward the outside in the vehicle width direction from the upright wall portion 28, it is formed inclined toward the vehicle lower side toward the vehicle rear side.

Between the upper end of the inclined rib 50 and the front end of the upper wall portion 46, a rear wall portion 52 that constitutes the rear end of the apron upper member 18 and extends in the vehicle up-down direction and the vehicle width direction is provided. Further, the lower end of the upper member 22, the lower wall portion 54 forming a boundary with the front side member 24 is erected toward the outside in the vehicle width direction from the upright wall portion 28, is formed along the vehicle front-rear direction.

That is, in the present embodiment, the upper member 22 has a boundary with other parts of the integrally molded member 25 by the upper wall portion 46, the rear wall portion 52 of the apron upper member 18, the inclined rib 50, the rear wall portion 48, and the lower wall portion 54.

Here, a plurality of first arcuate ribs (third ribs) 56 are extended from the inclined ribs 50 toward the vehicle upper side toward the vehicle rear side and gradually bulge in a convex shape toward the vehicle rear side and the vehicle lower side. The first arcuate ribs 56 are erected from the upright wall portion 28 toward the outside in the vehicle width direction, and are arranged with a gap therebetween. The upper end of the first arcuate rib 56 is connected to the upper wall portion 46 and the rear wall portion 48 (the boundary of the upper member 22).

In the present embodiment, the plurality of second arcuate ribs (third ribs) 58 intersect the plurality of first arcuate ribs 56. The second arcuate ribs 58 are formed so as to gradually bulge in a convex shape toward the vehicle rear side and toward the vehicle upper side while being directed toward the vehicle lower side toward the vehicle rear side.

Further, the second arcuate ribs 58 are erected from the upright wall portion 28 toward the outside in the vehicle width direction, and are arranged in a state of being provided with a gap therebetween. The front end of the second arcuate rib 58 is connected to the inclined rib 50, the rear wall portion 52, and the upper wall portion 46 (the boundary of the upper member 22), respectively, and the rear end of the second arcuate rib 58 is connected to the lower wall portion 54 and the rear wall portion 48 (the boundary of the upper member 22).

In the present embodiment, as shown in 2A and 2B, the draft angle θ of the first arcuate rib 56 and the second arcuate rib 58 is larger than the draft angle θ′ of the rib 59 formed at a portion other than the upper member 22, such as the wheelhouse 14 (see FIG. 1) (θ>θ′).

### Front Pillar

Next, the front pillar 26 according to the present embodiment will be described.

As shown in FIG. 1, in the present embodiment, the pair of left and right front pillars 26 are provided on the rear sides of the pair of left and right upper members 22 and the pair of left and right front side members 24, respectively, and extend in the vehicle up-down direction and the vehicle front-rear direction, respectively. The pair of left and right front pillars 26 are connected by a crossmember 16 extending in the vehicle width direction.

In the present embodiment, a triangular rib (first rib) 60 connecting the front pillar 26 and the crossmember 16 is provided on the vehicle width direction inner surface 26A of the front pillar 26 and on the boundary portion 26B with the crossmember 16. For example, the triangular ribs 60 are provided at two positions in front and rear of the vehicle, and are formed to have a substantially triangular shape when viewed from the vehicle rear side.

The front pillar 26 extending in the vehicle up-down direction and the vehicle front-rear direction and the crossmember 16 extending in the vehicle width direction are formed in a substantially orthogonal state. Therefore, a gusset 61 having a rectangular plate shape is provided between the front pillar 26 and the crossmember 16.

As described above, by providing the gusset 61 between the front pillar 26 and the crossmember 16, the boundary portion 26B between the front pillar 26 and the crossmember 16 is located above the gusset 61. That is, the boundary-portion 26B between the front pillar 26 and the crossmember 16 refers to a portion that is a starting point of deformation when the front pillar 26 is deformed inward in the vehicle-width direction.

Further, in the present embodiment, from the outer surface 26C of the front pillar 26 in the vehicle width direction, the second rib 62 is erected along the vehicle up-down direction, the lower end portion of the second rib 62 when viewed from the outer side in the vehicle width direction overlaps with the triangular rib 60. In the second rib 62, the cross-sectional shape when cut in the width direction substantially orthogonal to the longitudinal direction forms a triangular shape, a rectangular shape, a trapezoidal shape, or the like.

### Operation and Effect of Vehicle Frontal Structure

Next, the operation and effects of the vehicle frontal structure according to the present embodiment will be described.

In the present embodiment, as shown in FIG. 1, a pair of left and right wheelhouses 14, a crossmember 16, and a pair of left and right front pillars 26 are provided, and these are integrally molded as an integrally molded member 25.

Here, in the present embodiment, a triangular rib 60 connecting the front pillar 26 and the crossmember 16 is provided on the inner surface 26A of the pair of left and right front pillars 26 and on the boundary portion 26B with the crossmember 16.

In the present embodiment, since the triangular rib 60 is formed, it is possible to resist the deformation of the pair of left and right front pillars 26 which tends to fall toward the inside in the vehicle width direction by the compressive force of the triangular rib 60 after the integrally molded member 25 is formed. Deformation of the front pillar 26 can be suppressed.

As described above, by suppressing the deformation of the pair of left and right front pillars 26 toward the inside in the vehicle width direction, in the present embodiment, the pair of left and right front pillars 26 can be included and molded in the integrally molded member 25.

Further, in the present embodiment, the triangular rib 60 can effectively suppress the deformation of the front pillar 26 with a minimum size and a simple shape. As described above, the deformation of the front pillar 26 is suppressed with the minimum size required, which contributes to the weight reduction of the vehicle 12.

Further, in the present embodiment, the second rib 62 is erected from the outer surface 26C of the front pillar 26, and the second rib 62 is formed along the vehicle up-down direction.

Thus, in the present embodiment, when the integrally molded member 25 is released from the mold at the time of forming the integrally molded member 25, the release resistance of the second rib 62 is added to the front pillar 26. When the integrally molded member 25 is released from the mold by the release resistance, a force toward the outside in the vehicle width direction acts on the pair of left and right front pillars 26. As a result, in the present embodiment, deformation (collapse) of the pair of left and right front pillars 26 toward the inside in the vehicle width direction can be suppressed with a simple configuration.

Further, in the present embodiment, a plurality of first arcuate ribs 56 and second arcuate ribs 58 are erected on the upper member 22 provided between the suspension tower 20 and the front pillar 26 provided in the wheelhouse 14. The first arcuate rib 56 and the second arcuate rib 58 are formed from the upright wall portion 28 toward the outside in the vehicle width direction.

Thus, in the present embodiment, the rigidity of the upper member 22 itself can be improved, and the deformation of the upper member 22 can be suppressed. As a result, it is possible to prevent the pair of left and right front pillars 26 provided on the vehicle rear side of the upper member 22 from falling along the vehicle width direction. In the upper member 22, a plurality of first arcuate ribs 56 and a plurality of second arcuate ribs 58 are erected from the upright wall portion 28. Accordingly, the collision energy can be absorbed by crushing the plurality of first arcuate ribs 56 and the second arcuate ribs 58 at the time of collision in the vehicle front-rear direction.

Here, in the present embodiment, as shown in 2A and 2B, the draft angle θ of the first arcuate rib 56 and the second arcuate rib 58 is larger than the draft angle θ′ of the rib 59 formed at a portion other than the upper member 22 (θ>θ′).

Thus, in the present embodiment, the releasability of the first arcuate rib 56 and the second arcuate rib 58 can be improved. When the integrally molded member 25 is released from the mold at the time of molding the integrally molded member 25, it is possible to reduce the adverse effect (deformation or the like) of the releasability caused by providing the plurality of first arcuate ribs 56 and the second arcuate ribs 58.

### Supplementary Explanation of Embodiment

In the above-described embodiment, the upper member 22 describes that a boundary with another portion is formed by the rear wall portion 52, the inclined rib 50, and the lower wall portion 54 of the apron upper member 18. However, in this case, only the boundary is set for convenience in order to describe the upper member 22. Since the upper member 22 is a part of the integrally molded member 25 including the wheelhouse 14, where the range of the upper member 22 is set can be changed as appropriate. For example, the rear end portion of the front side member 24 may be a part of the upper member 22.

Further, in the present embodiment, the first arcuate rib 56 and the second arcuate rib 58 are formed in an arc shape, but they do not necessarily have to be formed in an arc shape, and may be formed in a straight line shape. The thickness of the first arcuate rib 56 and the second arcuate rib 58 does not necessarily have to be constant along the extending direction, and for example, the intersection with another portion may be thick.

The heights of the first arcuate rib 56 and the second arcuate rib 58 do not necessarily have to be constant along the extending direction. In consideration of the balance of the cooling time with other parts of the upper member 22 during the forming of the integrally molded member 25, the first arcuate rib 56 and the second arcuate rib 58 may be formed to be partially low in order to accelerate the cooling.

In the present embodiment, a triangular rib 60 connecting the inner surface 26A of the pair of left and right front pillars 26 and the crossmember 16 is provided on the boundary portion 26B of the front pillar 26 with the crossmember 16. The triangular ribs 60 may be provided to include the boundary portion 26B, and thus may be further formed along the up-down direction of the vehicle. Also, the ribs formed including the boundary portion 26B need not be triangular ribs 60. For example, it may have a substantially trapezoidal shape when viewed from the vehicle rear side.

Further, in the present embodiment, the second rib 62 is erected from the outer surface 26C of the front pillar 26 and the second rib 62 is formed along the vehicle up-down direction. The lower end portion of the second rib 62 is overlapped with the triangular rib 60 when viewed from the outside in the vehicle width direction, but the lower end portion of the second rib 62 is not necessarily overlapped with the triangular rib 60 when viewed from the outside in the vehicle width direction.

Incidentally, in the present embodiment, the left and right wheelhouses 14, the left and right upper members 22 and the crossmember 16 are integrally molded as an integrally molded member 25 by casting an aluminum alloy or the like as a material, but the present disclosure is not limited thereto. The integrally molded member 25 may be integrally molded of, for example, CFRP, GFRP or the like.

Further, in the present embodiment, the front side member 24 is integrally formed with the wheelhouse 14, but it is not necessary to be integrally formed. As a separate member, the front side member 24 may be fixed to the lower side of the wheelhouse 14. In this case, the material can be changed between the wheelhouse 14 and the front side member 24, and the manufacturing method can be changed from that of the integrally molded member 25 such as extrusion molding.

An embodiment of the present disclosure has been described above. The disclosure is not limited to such embodiments. One embodiment and various modifications may be used in combination as appropriate. Various embodiments may be made without departing from the spirit of the present disclosure.

What is claimed is:

1. A vehicle frontal structure, comprising:
a pair of right and left wheelhouses, each configured including an upright wall portion that extends in a vehicle front-rear direction and also a vehicle up-down direction, with respective right and left front wheels being disposed in each of the wheelhouses;
a crossmember that extends in a vehicle width direction to connect the right and left wheelhouses, and that is integrally molded with the right and left wheelhouses; and
a pair of right and left pillars that is provided on a rearward side in the vehicle front-rear direction from the right and left wheelhouses, respectively, and extending in the vehicle front-rear direction and also in the vehicle up-down direction, and integrally molded with the right and left wheelhouses, wherein
first ribs are each fashioned connecting inner face sides of the right and left pillars in the vehicle width direction with the crossmember.

2. The vehicle frontal structure according to claim 1, wherein each first rib is provided including a boundary portion of each pillar with respect to the crossmember, and is a triangular rib with a substantially triangular shape as viewed from a vehicle rearward side.

3. The vehicle frontal structure according to claim 1, wherein second ribs are erected from outer faces of the pillars in the vehicle width direction along the vehicle up-down direction.

4. The vehicle frontal structure according to claim 1, wherein a plurality of third ribs is erected from each of the upright wall portions toward an outer side in the vehicle width direction, at an upper member that is located between a suspension tower provided in the wheelhouse and the pillar.

5. The vehicle frontal structure according to claim 4, wherein a draft angle of the third ribs is greater in inclination angle than a draft angle of the ribs at portions other than at the upper member.
